(19) United States
(12) Patent Application Publication
(10) Pub. No.: US 2026/0082249 A1
(43) Pub. Date: Mar. 19, 2026

(54) MEASUREMENT APPARATUS AND WIRING DIAGRAM CREATION METHOD THEREOF

(71) Applicant: ANRITSU CORPORATION, Kanagawa (JP)

(72) Inventors: Seiya KATO, Kanagawa (JP); Kuniyuki YOKOBORI, Kanagawa (JP); Hiroaki IIDA, Kanagawa (JP)

(21) Appl. No.: 19/260,699

(22) Filed: Jul. 7, 2025

(30) Foreign Application Priority Data
Sep. 17, 2024 (JP) 2024-160073

(51) Int. Cl. H04W 24/08

(52) U.S. Cl. CPC H04W 24/08

(57) ABSTRACT

The measurement apparatus includes a measurement test selection unit that selects a test item to be measured, a measurement condition analysis unit that analyzes a measurement condition of the selected test item, a wiring condition selection unit that inputs a frequency band to be measured and an antenna terminal of a mobile terminal to be used in the frequency band as a wiring condition for the selected test item, a recommended wiring calculation unit that calculates a wiring method that satisfies the wiring condition and the measurement condition and minimizes the number of times of reconnection to the cable between the port of the measurement device and the antenna terminal of the mobile terminal, and a wiring method display unit that displays the wiring method calculated by the recommended wiring calculation unit as a wiring diagram.

### TECHNICAL FIELD

The present invention relates to a measurement apparatus that performs a measurement test of a mobile terminal.

### BACKGROUND ART

In a case where a mobile terminal such as a portable phone or a data communication terminal is developed, it is necessary to test whether or not the developed mobile terminal can normally perform communication. Therefore, a test in which a mobile terminal to be tested is connected to a test apparatus that operates as a simulated base station that simulates the functions of an actual base station, communication is performed between the test apparatus and the mobile terminal, and the content of the communication is confirmed is performed.

Among such tests, there is a conformance test of checking whether the mobile terminal complies with the 3GPP (3rd Generation Partnership Project) standards.

In the 5-th generation mobile communication system (hereinafter, also referred to as “5G”), frequency bands are widely defined as frequency range 1 (FR1: 410 to 7125 MHZ) and frequency range 2 (FR2: 24250 to 71000 MHZ). In addition, the formulation of a frequency range 3 (FR3: 7125 to 24250 MHZ) of an intermediate frequency band between FR1 and FR2 is being promoted.

In executing the conformance test, FR1 is defined to directly connect a measurement apparatus and a mobile terminal to perform the measurement test.

Patent Document 1 discloses a configuration capable of switching connection between a plurality of input-output ports of base station apparatuses and a plurality of input-output ports of terminal apparatuses by setting connection of the plurality of input-output ports of the base station apparatuses and the plurality of input-output ports of the terminal apparatuses to which a plurality of antennas are connected, on the plurality of base station apparatuses using a plurality of distributers or couplers, and selecting a base station apparatus to be connected to a terminal apparatus.

### RELATED ART DOCUMENT

### Patent Document

[Patent Document 1] Japanese Patent No. 7379744

### DISCLOSURE OF THE INVENTION

### Problem that the Invention is to Solve

However, in such a configuration, a base station apparatus needs to be prepared for each wiring to be switched, which causes an increase in cost. In addition, in a case where the number of antennas of the terminal apparatus increases, the number of distributers or couplers increases accordingly, thereby causing an increase in cost.

In addition, since the distributer or the coupler is connected in multiple stages, the loss of the signal is significantly increased, so that it is not possible to set the level as defined by the standard.

As the number of frequency bands to be utilized increases, the number of antennas for the mobile terminals also increases, so that it is expected that the connection between the antennas in the mobile terminals and the measurement apparatus is complicated.

In addition, a combination of bands indicating frequency bands, such as a non-standalone (NSA) method in which long term evolution (LTE) and 5G are linked and higher-level carrier aggregation (CA), tends to increase with the addition of functions of the mobile terminal, and in a case where a measurement test is performed, the user needs to perform reconnection each time or to consider wiring that allows the measurement test to be continuously performed even in a case of not performing reconnection.

The connection configuration between the mobile terminal and the measurement apparatus, which allows the measurement test to be continued even in a case where the connection configuration between the mobile terminal and the measurement apparatus is changed, is complicated due to an increase in the number of antennas of the mobile terminal, and takes time and effort for the user to think.

Therefore, an object of the present invention is to provide a measurement apparatus that can reduce the number of times of reconnection with the antenna of the mobile terminal and improve the efficiency of the measurement test.

### Means for Solving the Problem

According to an aspect of the present invention, there is provided a measurement apparatus (1) that performs a measurement test of a signal transmitted from a mobile terminal (100) by performing communication with the mobile terminal by a measurement device (11) including a plurality of ports connected to a plurality of antenna terminals of the mobile terminal via a cable, the measurement apparatus including a measurement test selection unit (13) that selects a test item to be measured; a measurement condition analysis unit (14) that analyzes a measurement condition of the selected test item; a wiring condition selection unit (16) that inputs a frequency band to be measured and an antenna terminal of the mobile terminal to be used in the frequency band as a wiring condition for the selected test item; a recommended wiring calculation unit (17) that calculates a wiring method that satisfies the wiring condition and the measurement condition and minimizes the number of times of reconnection to the cable between the port of the measurement device and the antenna terminal of the mobile terminal; and a wiring method display unit (18) that displays the wiring method calculated by the recommended wiring calculation unit as a wiring diagram.

With this configuration, the wiring method that satisfies the wiring condition and the measurement condition and minimizes the number of times of reconnection to the cable is displayed as the wiring diagram. Therefore, it is possible to improve the efficiency of the measurement test.

In the measurement apparatus according to the aspect of the present invention, the recommended wiring calculation unit formulates the wiring condition and the measurement condition, and calculates the wiring method that minimizes the number of times of reconnection to the cable between the port of the measurement device and the antenna terminal of the mobile terminal under a formulated condition by optimization of combination.

With this configuration, the wiring method that satisfies the wiring condition and the measurement condition and minimizes the number of times of reconnection to the cable is calculated by the optimization of the combination. Therefore, it is possible to easily calculate the wiring method, and it is possible to improve the efficiency of the measurement test.

In the measurement apparatus according to the aspect of the present invention, the wiring method display unit displays the frequency band that can be measurable by the wiring diagram, together with the wiring diagram.

With this configuration, the frequency band that can be measured by the wiring diagram is displayed together with the wiring diagram. Therefore, it is possible to easily know the frequency band that can be measured in the displayed wiring diagram, and it is possible to improve the efficiency of the measurement test.

In the measurement apparatus according to the aspect of the present invention, the wiring method display unit displays the antenna terminal of the mobile terminal to be used in the frequency band, together with the frequency band that can be measurable by the wiring diagram.

With this configuration, the antenna terminal of the mobile terminal to be used in the frequency band is displayed together with the frequency band that can be measured by the wiring diagram. Therefore, it is possible to easily know the frequency band that can be measured in the displayed wiring diagram and the antenna terminal to be used in the frequency band, and it is possible to improve the efficiency of the measurement test.

According to another aspect of the present invention, there is provided a wiring diagram creation method of a measurement apparatus (1) that performs a measurement test of a signal transmitted from a mobile terminal (100) by performing communication with the mobile terminal by a measurement device (11) including a plurality of ports connected to a plurality of antenna terminals of the mobile terminal via a cable, the wiring diagram creation method including a step of selecting a test item to be measured; a step of analyzing a measurement condition of the selected test item; a step of inputting a frequency band to be measured and an antenna terminal of the mobile terminal to be used in the frequency band as a wiring condition for the selected test item; a step of calculating a wiring method that satisfies the wiring condition and the measurement condition and minimizes the number of times of reconnection to the cable between the port of the measurement device and the antenna terminal of the mobile terminal; and a step of displaying the calculated wiring method as a wiring diagram.

In addition, in the wiring diagram creation method according to the aspect of the present invention, the step of calculating includes a step of formulating the wiring condition and the measurement condition and calculating the wiring method that minimizes the number of times of reconnection to the cable between the port of the measurement device and the antenna terminal of the mobile terminal under a formulated condition by optimization of combination.

In the wiring diagram creation method according to the aspect of the present invention, the step of displaying includes a step of displaying the frequency band that can be measurable by the wiring diagram, together with the wiring diagram.

In the wiring diagram creation method according to the aspect of the present invention, the step of displaying includes a step of displaying the antenna terminal of the mobile terminal to be used in the frequency band, together with the frequency band that can be measurable by the wiring diagram.

With this configuration, the wiring method that satisfies the wiring condition and the measurement condition and minimizes the number of times of reconnection to the cable is displayed as the wiring diagram. Therefore, it is possible to improve the efficiency of the measurement test.

### Advantage of the Invention

The present invention can provide a measurement apparatus that can improve the efficiency of a measurement test.

### BRIEF DESCRIPTION OF THE DRAWINGS

FIG. 1 is a block diagram of a measurement apparatus according to an embodiment of the present invention.

FIG. 2 is a diagram showing an example of a wiring condition setting screen of the measurement apparatus according to the embodiment of the present invention.

FIG. 3 is a diagram showing a display example in a case where reconnection is not performed in the wiring diagram of the measurement apparatus according to the embodiment of the present invention.

FIG. 4 is a diagram showing a display example of a first pattern in a case where the reconnection to the wiring diagram of the measurement apparatus according to the embodiment of the present invention is performed once.

FIG. 5 is a diagram showing a display example of a second pattern in a case where the reconnection to the wiring diagram of the measurement apparatus according to the embodiment of the present invention is performed once.

FIG. 6 is a flowchart illustrating a procedure of a wiring diagram creation process of the measurement apparatus according to the embodiment of the present invention.

### BEST MODE FOR CARRYING OUT THE INVENTION

Hereinafter, a measurement apparatus according to an embodiment of the present invention will be described in detail with reference to the drawings.

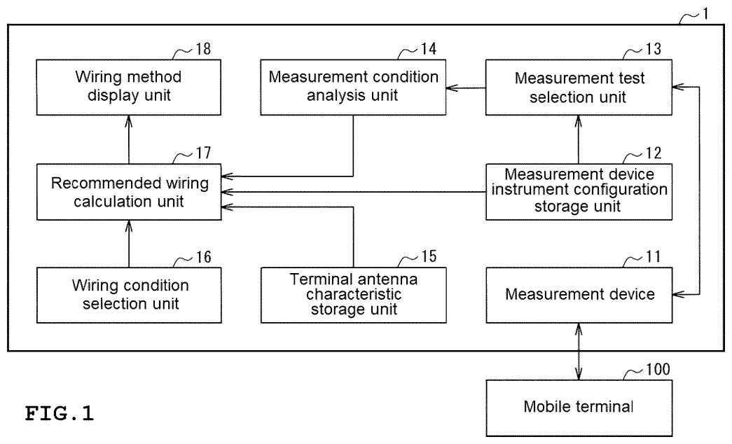

In FIG. 1, a measurement apparatus 1 according to an embodiment of the present invention transmits and receives a radio frequency (RF) signal to and from a mobile terminal 100 by wire via a coaxial cable or the like as a pseudo base station.

The measurement apparatus 1 includes a measurement device 11, a measurement device instrument configuration storage unit 12, a measurement test selection unit 13, a measurement condition analysis unit 14, a terminal antenna characteristic storage unit 15, a wiring condition selection unit 16, a recommended wiring calculation unit 17, and a wiring method display unit 18.

The measurement device 11 transmits and receives an RF signal to and from the mobile terminal 100 under the control of the measurement test selection unit 13. The measurement device 11 outputs a state of communication with the mobile terminal 100 and the like to the measurement test selection unit 13.

The measurement device 11 is configured to perform 5G communication with the mobile terminal 100 in accordance with the 5G standard.

The measurement device 11 is provided with an RF port for transmitting and receiving an RF signal with the mobile terminal 100. By connecting the RF port and the antenna terminal of the mobile terminal 100 with a cable, the measurement apparatus 1 and the mobile terminal 100 can transmit and receive the RF signal.

The measurement device 11 includes, for example, a plurality of slots, and a plurality of RF ports are provided in each slot. In addition, the functions that can be provided in units of slots are determined. The functions that can be provided in the slot include the output of the interference wave.

The measurement device instrument configuration storage unit 12 stores an instrument configuration incorporated in the measurement device 11. The measurement device instrument configuration storage unit 12 stores, for example, the number of ports connected to the antenna terminal of the mobile terminal 100, functions that can be used at each port, and the like.

The measurement test selection unit 13 displays the test items of the conformance test on a display unit (not shown) such as a display in response to an instruction input to an operation unit such as a keyboard or a mouse (not shown), and selects the test items of the conformance test to be measured. In addition, the measurement test selection unit 13 controls the measurement device 11 in response to an instruction input to the operation unit to execute a measurement test of the conformance test, and displays the result on the display unit.

The measurement condition analysis unit 14 analyzes the measurement condition of the test items of the conformance test and outputs the result to the recommended wiring calculation unit 17. The measurement condition analysis unit 14 analyzes the measurement conditions such as the use of a specific device for the selected test items of the conformance test.

The terminal antenna characteristic storage unit 15 stores antenna information of the mobile terminal 100. The terminal antenna characteristic storage unit 15 stores antenna characteristic data such as the number of antennas of the mobile terminal 100 and a combination of antennas used for each band indicating a frequency band to be measured.

The wiring condition selection unit 16 causes the user to input the antenna of the mobile terminal 100 used in the band as a condition of the band used in the test item to be measured. The wiring condition selection unit 16 displays, for example, a screen for inputting the antenna to be used for each band on the display unit, and inputs the band and the antenna to be used by the operation of the operation unit.

The recommended wiring calculation unit 17 calculates a wiring method that satisfies the wiring condition of the band designated by the wiring condition selection unit 16 and the measurement condition of the test item selected by the measurement test selection unit 13, and minimizes the number of times of reconnection to the cable between the port of the measurement apparatus 1 and the antenna terminal of the mobile terminal 100.

The wiring method display unit 18 displays the wiring method calculated by the recommended wiring calculation unit 17 on the display unit as a wiring diagram in which a connection state of the cable between the port of the measurement apparatus 1 and the antenna terminal of the mobile terminal 100 is shown in the drawing.

Here, the measurement apparatus 1 is configured by a computer apparatus (not shown) provided with a communication module for communicating with the mobile terminal 100. The computer device includes a central processing unit (CPU), a read only memory (ROM), a random access memory (RAM), a storage device such as a hard disk device, an input and output port, and a touch panel (not illustrated).

A program for causing the computer apparatus to function as the measurement apparatus 1 is stored in the ROM and the hard disk device of the computer apparatus. That is, the computer apparatus functions as the measurement apparatus 1 by the CPU executing the program stored in the ROM by using the RAM as a work area.

As described above, in the present embodiment, the measurement device instrument configuration storage unit 12, the measurement test selection unit 13, the measurement condition analysis unit 14, the terminal antenna characteristic storage unit 15, the wiring condition selection unit 16, the recommended wiring calculation unit 17, and the wiring method display unit 18 are configured by the CPU, and the measurement device 11 is configured by a communication module.

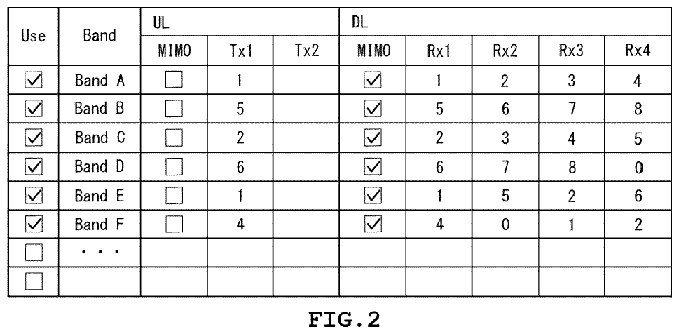

In the measurement apparatus 1 having such a configuration, the wiring condition selection unit 16 displays, for example, a wiring condition setting screen as shown in FIG. 2 and causes the user to input the wiring condition.

In FIG. 2, the name of the band can be input in the column of “Band”. By setting a check in the column of “Use”, it is possible to set the band to be used.

In the column of “UL”, the uplink wiring condition can be input. In the column of “MIMO” in the column of “UL”, whether or not to use a multiple input multiple output (MIMO) configuration can be input. By setting a check in the column of “MIMO”, the MIMO configuration can be set.

In the columns of “Tx1” and “Tx2” of the column of “UL”, the number of the antenna used for the uplink can be input.

In the column of “DL”, the downlink wiring condition can be input. In the column of “MIMO” in the column of “DL”, whether or not to set the MIMO configuration can be input. By setting a check in the column of “MIMO”, the MIMO configuration can be set.

In the columns of “Rx1”, “Rx2”, “Rx3”, and “Rx4” of the column of “DL”, the number of the antenna used for the downlink can be input. In the example of FIG. 2, the mobile terminal 100 includes antennas from 0 to 8.

For example, a band of “Band A” is set to use an antenna 1 for the uplink and to use antennas 1, 2, 3, and 4 for the downlink.

In FIG. 2, the wiring conditions of the plurality of bands can be set, and it is possible to set whether or not each band is used in the measurement test.

Based on the wiring condition set in this way and the measurement condition analyzed by the measurement condition analysis unit 14 from the test items selected by the measurement test selection unit 13, the recommended wiring calculation unit 17 calculates the wiring method that satisfies the wiring condition and the measurement condition, and minimizes the number of times of reconnection to the cable between the port of the measurement apparatus 1 and the antenna terminal of the mobile terminal 100.

The recommended wiring calculation unit 17 performs, for example, a process of optimizing the combination to calculate the wiring method in which the wiring condition and the measurement condition are satisfied and the number of times of reconnection to the cable between the port of the measurement apparatus 1 and the antenna terminal of the mobile terminal 100 is minimized.

The recommended wiring calculation unit 17 defines the decision variable as follows.

$${x}_{s , r , a , p} ∈ \{ 0 , 1 \} \qquad ( s = 0 , 1 )$$

$$( r = 0 , 1 , 2 , 3 )$$

$$( a = 0 , … , A - 1 )$$

$$( p = 0 , … , P - 1 )$$

s is an index of the slot of the measurement device 11, and r is an index of the RF port for each slot. In this example, there are two slots, four RF ports are provided in each slot, and a total of eight RF ports are provided.

a is an index of the antenna of the mobile terminal 100. a=1 indicates 1 of the antenna. A is the total number of antennas.

p is an index of the reconnection pattern. p=1 indicates the second pattern. P is the total number of patterns.

x_{s,r,a,p} takes either 0 or 1. In a case where the value is 0, there is no connection in the combination of _{s,r,a,p}, and a case where the value is 1 shows that the RF port of the measurement apparatus 1 and the antenna terminal of the mobile terminal 100 are connected by a cable in the combination of _{s,r,a,p}.

For example, a case where x_{0,0,0,0}=1 shows that the RF port 0 of the slot 0 is connected to the antenna 0 in a first reconnection pattern. In addition, a case where x_{1,2,3,4}=1 shows that the RF port 2 of the slot 1 is connected to the antenna 3 in a fifth reconnection pattern.

In a case of x_{s,r,a,p}, a problem is to decide either 0 or 1 for all x_{s,r,a,p}.

A constraint condition is defined for such a problem. For example, in a case where a splitter is used, one RF port can be connected to two different antennas of the mobile terminal 100, so that the constraint condition can be represented by an expression as follows.

$${\sum }_{a = \{ 0 , … , A - 1 \}} {x}_{s , r , a , p} \leq 2 \qquad \begin{matrix}( s = 0 , 1 ) \\ ( r = 0 , 1 , 2 , 3 ) \\ ( p = 0 , … , P - 1 )\end{matrix}$$

This represents that, for a certain s, r, and p, even in a case where all of a=0 to A−1 are added, the result is 2 or less.

In addition, for a certain band, all the antennas to be used need to be connected to some RF ports, so that the constraint condition can be represented by the following expression.

$${\sum }_{s = \{ 0 , 1 \}} {\sum }_{r = \{ 0 , … , 3 \}} {x}_{s , r , a , p} \geq 1 \begin{matrix}where a is a used in Band \\ p is certain one of p .\end{matrix}$$

For the antenna used in the band to be measured, the above expression is satisfied in the same reconnection pattern.

The recommended wiring calculation unit 17 calculates the wiring method using a program that performs combination optimization for outputting a solution that satisfies the test condition to minimize the reconnection pattern, for example, by inputting such a test condition as a parameter to minimize the reconnection pattern.

The wiring method display unit 18 displays the connection state as a wiring diagram based on all the results of x_{s,r,a,p} calculated by the recommended wiring calculation unit 17.

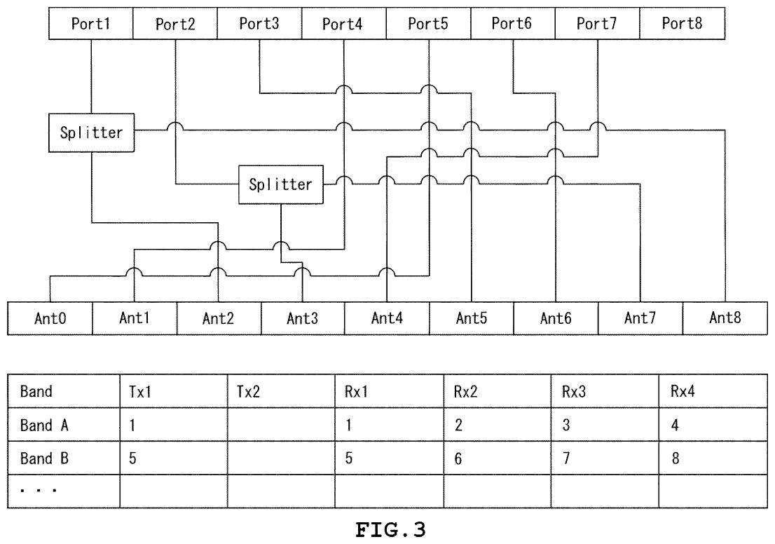

The wiring method display unit 18 displays, for example, a wiring diagram as shown in FIG. 3. FIG. 3 shows a case where all the conditions can be measured with one pattern of connection using two splitters while satisfying the wiring condition shown in FIG. 2.

In FIG. 3, a list of bands that can be measured with this pattern is displayed among the input wiring condition below the wiring diagram.

As shown in the wiring diagram of FIG. 3, the RF port of the measurement apparatus 1 and the antenna terminal of the mobile terminal 100 are connected by a cable and a splitter, so that the measurement can be performed while satisfying the conditions of the Bands A to F shown in FIG. 2.

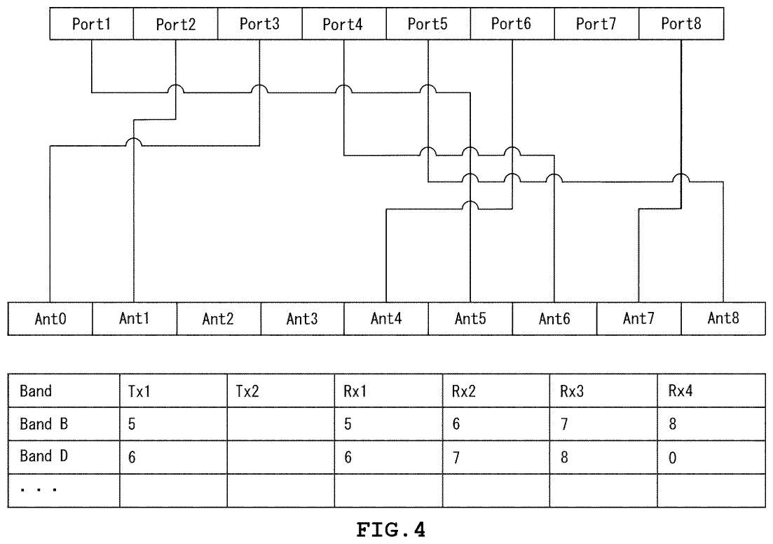

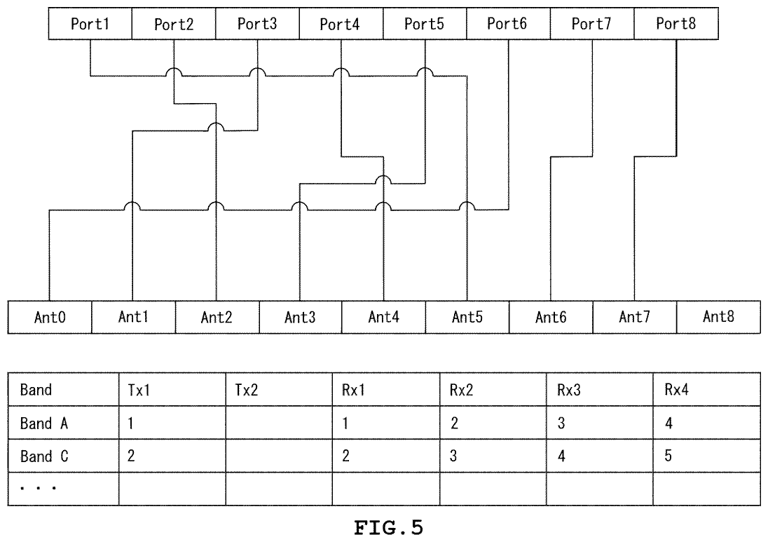

FIGS. 4 and 5 show a case where all conditions can be measured with two patterns of connections without using a splitter while satisfying the wiring conditions shown in FIG. 2.

In FIGS. 4 and 5, a list of bands that can be measured with this pattern is displayed among the input wiring conditions below the wiring diagram.

In FIG. 4, in this connection, the measurement at Band B, D, . . . can be performed without changing the connection of the cable.

In FIG. 5, in this connection, the measurement at Band A, C, . . . can be performed without changing the connection of the cable.

In FIGS. 3 to 5, the lines indicating the cables to be connected are shown in black, but in a case where the cables are displayed in different colors for each cable, the connection is facilitated.

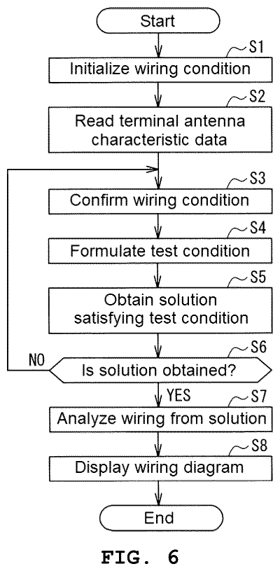

A wiring diagram creation process by the measurement apparatus 1 according to the present embodiment configured as described above will be described with reference to FIG. 6. The wiring diagram creation process described below is started in a case where the creation of the wiring diagram is selected by the operation of the user.

In step S1, the recommended wiring calculation unit 17 initializes the wiring condition. After the process of step S1 is executed, the recommended wiring calculation unit 17 executes the process of step S2.

In step S2, the recommended wiring calculation unit 17 reads the antenna characteristic data of the mobile terminal 100 from the terminal antenna characteristic storage unit 15. After the process of step S2 is executed, the wiring condition selection unit 16 executes the process of step S3.

In step S3, the wiring condition selection unit 16 displays a wiring condition setting screen and causes the user to input the wiring condition. After the process of step S3 is executed, the recommended wiring calculation unit 17 executes the process of step S4.

In step S4, the recommended wiring calculation unit 17 formulates the test conditions of the wiring condition input by the wiring condition selection unit 16, the measurement condition analyzed by the measurement condition analysis unit 14, and the instrument configuration of the measurement device 11 stored in the measurement device instrument configuration storage unit 12. After the process of step S4 is executed, the recommended wiring calculation unit 17 executes the process of step S5.

In step S5, the recommended wiring calculation unit 17 obtains a solution that satisfies the test condition using a program by inputting the formulated test condition to minimize the reconnection pattern. After the process of step S5 is executed, the recommended wiring calculation unit 17 executes the process of step S6.

In step S6, the recommended wiring calculation unit 17 determines whether or not a solution satisfying the test condition is obtained.

In a case where it is determined that a solution satisfying the test conditions is obtained, the wiring method display unit 18 executes the process of step S7. In a case where it is determined that the solution satisfying the test condition is not obtained, the wiring condition selection unit 16 executes the process of step S3 to request the review of the wiring condition.

In step S7, the wiring method display unit 18 analyzes the wiring from the obtained solution to create a wiring diagram. After the process of step S7 is executed, the wiring method display unit 18 executes the process of step S8.

In step S8, the wiring method display unit 18 displays the created wiring diagram. After the process of step S8 is executed, the wiring method display unit 18 ends the wiring diagram creation process.

As described above, in the above-described embodiment, the recommended wiring calculation unit 17 calculates the wiring method that satisfies the wiring condition of the band designated by the wiring condition selection unit 16 and the measurement condition of the test item selected by the measurement test selection unit 13, and minimizes the number of times of reconnection to the cable between the RF port of the measurement device 11 and the antenna terminal of the mobile terminal 100, and the wiring method display unit 18 displays the calculated wiring method as the wiring diagram.

As a result, the wiring method that satisfies the wiring condition and the measurement condition and minimizes the number of times of reconnection to the cable is displayed as the wiring diagram. Therefore, it is possible to improve the efficiency of the measurement test.

In addition, the recommended wiring calculation unit 17 formulates the wiring condition and the measurement condition, and calculates the wiring method that minimizes the number of times of reconnection to the cable between the RF port of the measurement device 11 and the antenna terminal of the mobile terminal 100 under the formulated condition by the optimization of the combination.

As a result, the wiring method that satisfies the wiring condition and the measurement condition and minimizes the number of times of reconnection to the cable is calculated by the optimization of the combination. Therefore, it is possible to easily calculate the wiring method, and it is possible to improve the efficiency of the measurement test.

In addition, the wiring method display unit 18 displays a band that can be measured by the wiring diagram together with the wiring diagram.

As a result, the band that can be measured by the wiring diagram is displayed together with the wiring diagram. Therefore, it is possible to easily know the band that can be measured in the displayed wiring diagram, and it is possible to improve the efficiency of the measurement test.

In addition, the wiring method display unit 18 displays the antenna terminal of the mobile terminal 100 used in the band together with the band that can be measured by the wiring diagram.

Accordingly, the antenna terminal of the mobile terminal 100 used in the band is displayed together with the band that can be measured by the wiring diagram. Therefore, it is possible to easily know the band that can be measured in the displayed wiring diagram and the antenna terminal used in the band, and it is possible to improve the efficiency of the measurement test.

Although an embodiment of the present invention has been disclosed, it will be apparent that modifications may be made by those skilled in the art without departing from the scope of the present invention. All such modifications and equivalents are intended to be included in the following claims.

### DESCRIPTION OF REFERENCE NUMERALS AND SIGNS

1 Measurement Apparatus
11 Measurement Device
12 Measurement Device Instrument Configuration Storage Unit
13 Measurement Test Selection Unit
14 Measurement Condition Analysis Unit
15 Terminal Antenna Characteristic Storage Unit
16 Wiring Condition Selection Unit
17 Recommended Wiring Calculation Unit
18 Wiring Method Display Unit
100 Mobile Terminal

What is claimed is:

1. A measurement apparatus that performs a measurement test of a signal transmitted from a mobile terminal by performing communication with the mobile terminal by a measurement device including a plurality of ports connected to a plurality of antenna terminals of the mobile terminal via a cable, the measurement apparatus comprising:
a measurement test selection unit that selects a test item to be measured;
a measurement condition analysis unit that analyzes a measurement condition of the selected test item;
a wiring condition selection unit that inputs a frequency band to be measured and an antenna terminal of the mobile terminal to be used in the frequency band as a wiring condition for the selected test item;
a recommended wiring calculation unit that calculates a wiring method that satisfies the wiring condition and the measurement condition and minimizes the number of times of reconnection to the cable between the port of the measurement device and the antenna terminal of the mobile terminal; and
a wiring method display unit that displays the wiring method calculated by the recommended wiring calculation unit as a wiring diagram.

2. The measurement apparatus according to claim 1,
wherein the recommended wiring calculation unit formulates the wiring condition and the measurement condition, and calculates the wiring method that minimizes the number of times of reconnection to the cable between the port of the measurement device and the antenna terminal of the mobile terminal under a formulated condition by optimization of combination.

3. The measurement apparatus according to claim 1,
wherein the wiring method display unit displays the frequency band that can be measurable by the wiring diagram, together with the wiring diagram.

4. The measurement apparatus according to claim 3,
wherein the wiring method display unit displays the antenna terminal of the mobile terminal to be used in the frequency band, together with the frequency band that can be measurable by the wiring diagram.

5. A wiring diagram creation method of a measurement apparatus that performs a measurement test of a signal transmitted from a mobile terminal by performing communication with the mobile terminal by a measurement device including a plurality of ports connected to a plurality of antenna terminals of the mobile terminal via a cable, the wiring diagram creation method comprising:
a step of selecting a test item to be measured;
a step of analyzing a measurement condition of the selected test item;
a step of inputting a frequency band to be measured and an antenna terminal of the mobile terminal to be used in the frequency band as a wiring condition for the selected test item;
a step of calculating a wiring method that satisfies the wiring condition and the measurement condition and minimizes the number of times of reconnection to the cable between the port of the measurement device and the antenna terminal of the mobile terminal; and
a step of displaying the calculated wiring method as a wiring diagram.

6. The wiring diagram creation method according to claim 5,
wherein the step of calculating includes a step of formulating the wiring condition and the measurement condition and calculating the wiring method that minimizes the number of times of reconnection to the cable between the port of the measurement device and the antenna terminal of the mobile terminal under a formulated condition by optimization of combination.

7. The wiring diagram creation method according to claim 5,
wherein the step of displaying includes a step of displaying the frequency band that can be measurable by the wiring diagram, together with the wiring diagram.

8. The wiring diagram creation method according to claim 7,
wherein the step of displaying includes a step of displaying the antenna terminal of the mobile terminal to be used in the frequency band, together with the frequency band that can be measurable by the wiring diagram.
